(19) United States
(12) Patent Application Publication
(10) Pub. No.: US 2025/0199236 A1
(43) Pub. Date: Jun. 19, 2025

(54) ANTIRESONANT HOLLOW-CORE OPTICAL FIBER WITH OVAL-SHAPED DNE ELEMENT

(71) Applicant: Heraeus Quarzglas GmbH & Co. KG, Hanau (DE)

(72) Inventors: Manuel ROSENBERGER, Kleinostheim (DE); Tobias TIESS, Bitterfeld-Wolfen (DE)

(21) Appl. No.: 18/975,560

(22) Filed: Dec. 10, 2024

(30) Foreign Application Priority Data
Dec. 15, 2023 (EP) 23217113.2

(51) Int. Cl. G02B 6/02

(52) U.S. Cl. CPC G02B 6/02328

(57) ABSTRACT

An anti-resonant hollow-core fiber includes a fiber cladding having an inner bore, a fiber longitudinal axis, and a fiber core radius R_Faser, and a number of anti-resonance units, each including an ARE element, an NE element, and a DNE element. The anti-resonance units are mutually spaced and are arranged so as to have no contact with one another at desired positions on an inner side of the inner bore. In the anti-resonance units, the ARE element has a circular cross section, the NE element is arranged in a first interior of the ARE element, and the DNE element is arranged at least partially into a second interior of the NE element.

### CROSS REFERENCE TO RELATED APPLICATIONS

This application claims priority pursuant to 35 U.S.C. 119 (a) to European Patent Application No. 23217113.2, filed Dec. 15, 2023, which application is incorporated herein by reference in its entirety.

### DESCRIPTION

### Background of the Invention

The invention relates to an anti-resonant hollow-core fiber.

### Prior Art

Hollow-core fibers have a core that comprises an evacuated cavity filled with gas or liquid. In hollow-core fibers, the interaction of light with the material of the core is less than in solid-core fibers. The refractive index of the core is smaller than that of the surrounding fiber cladding, so that light transmission by total reflection is not possible. Depending on the physical mechanism of light transmission, hollow-core fibers are divided into “photonic bandgap fibers” and “anti-resonant hollow-core fibers”.

In the embodiment of the hollow-core fiber referred to as “anti-resonant hollow-core fiber” (ARHCF), the hollow core region is surrounded by a fiber cladding in which what are known as anti-resonance units (also known as “anti-resonant elements” or “AREs”) are arranged. The walls of the anti-resonance units, which are distributed uniformly around the hollow core, can act as Fabry-Perot cavities operated in anti-resonance, which reflect the incident light and thus enable waveguiding in the fiber core.

This technology promises a hollow-core fiber with low optical attenuation, a very broad transmission spectrum (also in the UV or IR wavelength range) and low latency during data transmission.

From publication WO 2019 053412 A1, an anti-resonant hollow-core fiber is known in which the hollow core is surrounded by a fiber cladding with anti-resonance units. These anti-resonance units have three elements which are nested within each other:
an outer ARE element,
an NE element arranged in the ARE element, and
a DNE element arranged in the NE element.

However, it has proven to be disadvantageous that this design has an unfavorable correlation between
the waveguide loss of the fundamental mode on the one hand and
the difference in the effective mode index between higher core modes and lossy ARE modes on the other hand.

This makes such anti-resonant hollow-core fibers unsuitable for applications, especially in the telecommunications sector.

### Technical Problem

For industrial use, anti-resonant hollow-core fibers with low waveguide losses are required. Furthermore, an anti-resonant hollow-core fiber is required that can be produced easily and on a large scale. This is the only way to bring the costs of anti-resonant hollow-core fibers within reasonable limits. It is important to note that anti-resonant hollow-core fibers that produce good results on a laboratory scale are not necessarily suitable for large-scale use.

An aim of the invention is to provide an anti-resonant hollow-core fiber which overcomes the above-mentioned disadvantages.

An aim of the invention is to provide an anti-resonant hollow-core fiber which can be produced precisely and reproducibly and additionally exhibits low attenuation.

In particular, it is an aim of the invention to provide an anti-resonant hollow-core fiber which has particularly low waveguide losses.

In particular, it is an aim of the invention to provide an anti-resonant hollow-core fiber which efficiently attenuates higher-order modes in the fiber core.

In particular, it is an aim of the invention to provide an anti-resonant hollow-core fiber which has a favorable correlation between, on the one hand, low waveguide losses of the fundamental mode and, on the other hand, efficient attenuation of higher-order modes in the core.

### PREFERRED EMBODIMENTS OF THE INVENTION

A contribution to the at least partial fulfillment of at least one of the aforementioned objects is made by the features of the independent claims. The dependent claims provide preferred embodiments that contribute to the at least partial fulfillment of at least one of the objects.

The following embodiments of an anti-resonant hollow-core fiber contribute at least partially to fulfilling at least one of the aforementioned objects:

I1.I A first embodiment of an anti-resonant hollow-core fiber, comprising
a fiber cladding which comprises an inner bore,
a fiber longitudinal axis and a fiber core radius R_Faser,
a number of anti-resonance units, each comprising
   an ARE element,
   an NE element,
   a DNE element,
wherein the anti-resonance units are mutually spaced and are arranged so as to have no contact with one another at desired positions on an inner side of the inner bore,
wherein in the anti-resonance units
   the ARE element has a circular cross section,
   the NE element is arranged in a first interior of the ARE element, and
   the DNE element is arranged at least partially into a second interior (3470) of the NE element.
According to the invention, it is provided in this embodiment that in at least one anti-resonance unit
   the NE element has a circular-arc-like cross section and is connected to the DNE element along two connection seams,
   the DNE element has an oval cross section, and
   in cross section, a sum of the distances of any point on a DNE element wall from two focal points is the same for all points to less than 15% of the sum of the distances.

I2.I A further embodiment of an anti-resonant hollow-core fiber, comprising the features of the first embodiment, is characterized in that, in cross section, the sum of the distances of any point on the DNE element wall from two focal points is the same for all points to less than 10%, in particular less than 5% of the sum of the distances.

I3.I A further embodiment of an anti-resonant hollow-core fiber, comprising the features of at least one of the preceding two embodiments, is characterized in that the DNE element has a longest cross-sectional axis AL and a shortest cross-sectional axis AK.

I4.I A further embodiment of an anti-resonant hollow-core fiber, comprising the features of the third embodiment, is characterized in that the DNE element is arranged such that
the longest cross-sectional axis AL runs substantially parallel to the inner bore, and/or
the shortest cross-sectional axis AK is substantially perpendicular to the inner bore and aligned with the fiber longitudinal axis.

I5.I A further embodiment of an anti-resonant hollow-core fiber, comprising the features of the third or fourth embodiment, is characterized in that, for a ratio of the longest cross-sectional axis AL to the shortest cross-sectional axis AK, the following applies:

$$\frac{A L}{A K} = [ 1.1 ; 4.0 ]$$

I6.I A further embodiment of an anti-resonant hollow-core fiber, comprising the features of at least one of the preceding embodiments 3 to 5, is characterized in that, for a ratio of the longest cross-sectional axis AL to the shortest cross-sectional axis AK, the following applies:
it is greater than or equal to 1.15, in particular greater than or equal to 1.20, in particular greater than or equal to 1.25, in particular greater than or equal to 1.50; and
it is less than or equal to 3.80, in particular less than or equal to 3.60, in particular less than or equal to 3.50.

I7.I A further embodiment of an anti-resonant hollow-core fiber, comprising the features of at least one of the preceding embodiments, is characterized in that, for a ratio of an NE interior height H_NE, multiplied by a doubled NE circle radius NE_R, divided by a fiber core surface area A_Faser, the following applies:

$$\frac{H\_NE * ( 2 * NE\_R )}{A\_Faser} = [ 0.35 ; 0.7 ]$$

I8.I A further embodiment of an anti-resonant hollow-core fiber, comprising the features of at least one of the preceding embodiments, is characterized in that, for the ratio of the NE interior height H_NE, multiplied by the doubled NE circle radius NE_R, divided by the fiber core surface area A_Faser, the following applies:
it is greater than or equal to 0.4, in particular greater than or equal to 0.50, in particular greater than or equal to 0.56; and
it is less than or equal to 0.65, in particular less than or equal to 0.62, in particular less than or equal to 0.6.

I9.I A further embodiment of an anti-resonant hollow-core fiber, comprising the features of at least one of the preceding embodiments, is characterized in that, for a ratio of an ARE interior height H_ARE divided by a core radius R_Faser, the following applies:

$$\frac{H\_ARE}{R\_Faser} = [ 0.85 ; 1.25 ]$$

I10.I A further embodiment of an anti-resonant hollow-core fiber, comprising the features of at least one of the preceding embodiments, is characterized in that, for the ratio of the ARE interior height H_ARE divided by the core radius R_Faser, the following applies:
it is greater than or equal to 0.9, in particular greater than or equal to 0.95, in particular greater than or equal to 1.0; and
it is less than or equal to 1.2, in particular less than or equal to 1.15, in particular less than or equal to 1.1.

I11.I A further embodiment of an anti-resonant hollow-core fiber, comprising the features of at least one of the preceding embodiments, is characterized in that, for a ratio of the ARE interior height H_ARE, multiplied by the doubled NE circle radius NE_R, divided by an NE internal surface area A_NE, the following applies:

$$\frac{H\_ARE * ( 2 * NE\_R )}{A\_NE} = [ 0.2 ; 1. ]$$

I12.I A further embodiment of an anti-resonant hollow-core fiber, comprising the features of at least one of the preceding embodiments, is characterized in that, for the ratio of the ARE interior height H_ARE, multiplied by the doubled NE circle radius NE_R, divided by the NE internal surface area A_NE, the following applies:
it is greater than or equal to 0.25, in particular greater than or equal to 0.3; and
it is less than or equal to 0.95, in particular less than or equal to 0.8.

I13.I A further embodiment of an anti-resonant hollow-core fiber, comprising the features of at least one of the preceding embodiments, is characterized in that
the ARE element has a first circle radius R_ARE, and
the NE element has a second circle radius R_NE and a center point angle MW_NE.

I14.I A further embodiment of an anti-resonant hollow-core fiber, comprising the features of at least one of the preceding embodiments, is characterized in that the anti-resonant hollow-core fiber has three, four, five, six, seven or eight anti-resonance units.

I15.I A further embodiment of an anti-resonant hollow-core fiber, comprising the features of at least one of the preceding embodiments, is characterized in that at least one of the anti-resonance units comprises at least one of the following features:
the ARE element and/or the NE element and/or the DNE element comprises an amorphous solid, in particular a glass, in particular quartz glass,
the ARE element and/or the NE element and/or the DNE element consists of an amorphous solid, in particular a glass, in particular quartz glass,
at least two of ARE element, NE element and DNE element are of the same material, in particular comprise or consist of a glass having a refractive index of at least 1.4, in particular 1.4 to 3, in particular 1.4 to 2.8, and
a wall thickness of at least two of ARE element, NE element and DNE element is substantially the same.

I16.I A further embodiment of an anti-resonant hollow-core fiber, comprising the features of at least one of the preceding embodiments, is characterized in that the anti-resonant hollow-core fiber comprises at least one of the following features:
a fundamental attenuation of less than 1.0 dB/km, in particular of less than 0.25 dB/km, in particular of less than 0.1 dB/km, for a transported wavelength between 0.3 μm and 3.0 μm, in particular between 1.0 μm and 2.5 μm, and
a fundamental attenuation of less than 1 dB/km for a transported wavelength of up to 0.8 μm.

I17.I A further embodiment of an anti-resonant hollow-core fiber, comprising the features of at least one of the preceding embodiments, is characterized in that the anti-resonance unit comprises at least one of the following features:
a wall thickness of an ARE element wall of the ARE element and/or an NE element wall of the NE element and/or a DNE element wall of the DNE element is between 0.1 μm and 2.5 μm, in particular between 0.15 μm and 1.5 μm, in particular between 0.25 μm and 0.75 μm, in particular between 0.35 μm and 0.65 μm, in particular 0.5 μm,
a wall thickness of an ARE element wall of the ARE element and/or an NE element wall of the NE element and/or a DNE element wall of the DNE element is, at a signal wavelength of 1550 nm in the first transmission window, between 0.35 μm and 0.65 μm, in particular between 0.4 μm and 0.6 μm, in particular 0.5 μm,
a wall thickness of an ARE element wall of the ARE element and/or an NE element wall of the NE element and/or a DNE element wall of the DNE element is, at a signal wavelength of 1550 nm in the second transmission window, between 0.75 μm and 1.25 μm, in particular between 0.9 μm and 1.1 μm, in particular 1 μm.

I18.I A further embodiment of an anti-resonant hollow-core fiber, comprising the features of at least one of the preceding embodiments, is characterized in that the core radius R_Faser comprises at least one of the following features:
it is less than or equal to 26 μm, in particular less than or equal to 23 μm, in particular less than or equal to 20 μm; and
it is greater than or equal to 10 μm, in particular greater than or equal to 12 μm, in particular greater than or equal to 14 μm.

I19.I A further embodiment of an anti-resonant hollow-core fiber, comprising the features of at least one of the preceding embodiments, is characterized in that the ARE element comprises at least one of the following features:
a first circle radius R_ARE is less than or equal to 30 μm, in particular less than or equal to 25 μm, in particular less than or equal to 22.5 μm, in particular less than or equal to 16 μm; and
the first circle radius R_ARE is greater than or equal to 5 μm, in particular greater than or equal to 7 μm, in particular greater than or equal to 11.5 μm, in particular greater than or equal to 12.25 μm, in particular greater than or equal to 14.5 μm.

I20.I A further embodiment of an anti-resonant hollow-core fiber, comprising the features of at least one of the preceding embodiments, is characterized in that the NE element comprises at least one of the following features:
a second circle radius R_NE is less than or equal to 25 μm, in particular less than or equal to 19 μm, in particular less than or equal to 17 μm,
the second circle radius R_NE is greater than or equal to 1.5 μm, in particular greater than 2.5 μm, in particular greater than or equal to 3.5 μm,
a center point angle MW_NE is less than 340°, in particular less than 330°, in particular less than 320°; and
the center point angle MW_NE is greater than 180°, in particular greater than 200°, in particular greater than 220°.

I21.I A further embodiment of an anti-resonant hollow-core fiber, comprising the features of at least one of the preceding embodiments, is characterized in that the DNE element comprises at least one of the following features:
the longest cross-sectional axis AL is less than or equal to 20 μm, in particular less than or equal to 16.5 μm, in particular less than or equal to 14.6 μm;
the longest cross-sectional axis AL is greater than or equal to 4 μm, in particular greater than or equal to 6.5 μm, in particular greater than or equal to 8 μm;
the shortest cross-sectional axis AK is less than or equal to 12 μm, in particular less than or equal to 9.5 μm, in particular less than or equal to 8 μm; and
the shortest cross-sectional axis AK is greater than or equal to 1.5 μm, in particular greater than or equal to 2.5 μm, in particular greater than or equal to 4 μm.

I22.I A further embodiment of an anti-resonant hollow-core fiber, comprising the features of at least one of the preceding embodiments, is characterized in that all anti-resonance units have a design according to one of the preceding claims.

### DETAILED DESCRIPTION

Some of the features described are associated with the term “substantially.” The term “substantially” is to be understood in such a way that, under real conditions and manufacturing techniques, a mathematically exact interpretation of terms such as “elliptical”, “perpendicular”, “parallel”, “diameter” or “oval” can never be given exactly, but only within certain manufacturing error tolerances. For example, “substantially parallel axes” include an angle of −10 degrees to 10 degrees, in particular-5 degrees to 5 degrees, to each other. For example, a “device consisting substantially of quartz glass” comprises a quartz glass content of ≥95 to ≤100% by weight. Furthermore, “substantially perpendicular” includes an angle of 85 degrees to 95 degrees. A further specification of the term “substantially” is provided below for some features.

The above objects are at least partially achieved by an anti-resonant hollow-core fiber, comprising a fiber cladding (also referred to as cladding) which comprises an inner bore, a fiber longitudinal axis and a fiber core radius R_Faser, a number of anti-resonance units, each comprising
an ARE element,
an NE element, and
a DNE element,
   wherein the anti-resonance units are mutually spaced and are arranged so as to have no contact with one another at desired positions on an inner side of the inner bore, wherein in the anti-resonance units
the ARE element has a circular cross section,
the NE element is arranged in a first interior of the ARE element, and

the DNE element is arranged at least partially into a second interior of the NE element.

In this case, it is provided that in at least one anti-resonance unit
the NE element has a circular-arc-like cross section and is connected to the DNE element along two connection seams,
the DNE element has an oval cross section, and
in cross section, a sum of the distances of any point on a DNE element wall from two focal points is the same for all points to less than 15% of the sum of the distances.

Surprisingly, it was found that the oval geometry of the DNE element in combination with the circular-arc-like cross section of the NE element is advantageous for the waveguide losses of the fundamental mode.

The following modes are considered:
fundamental mode in the core
   also referred to as core fundamental modes, which propagate within a fiber core;
higher-order modes in the core
   also referred to as higher-order core modes (HOM),
modes in the ARE element
   also referred to as ARE modes, which propagate within a first interior of the ARE element,
modes in the NE element
   also referred to as NE modes, which propagate within a second interior of the NE element,
modes in the DNE element
   also referred to as DNE modes, which propagate within a third interior of the DNE element.

The confinement loss (also known as waveguide loss or waveguiding loss) indicates the attenuation of the respective mode.

The effective mode index n_{eff} indicates the phase velocity of the respective mode in the propagation direction along the fiber longitudinal axis via the relation vₚₕₐₛₑ=C/n_{eff}, where c denotes the speed of light in vacuum.

The mode index difference Δn_{eff} (ARE) denotes the difference between the effective mode index of the higher-order modes in the core and the effective mode index of the ARE modes:

$$Δ {n}_{eff} ( A R E ) = {n}_{eff , core - HOM} - {n}_{eff , ARE mode} .$$

Equivalently, the mode index difference Δn_{eff} (NE) is the difference between the effective mode index of the higher-order modes in the core and the effective mode index of the NE mode:

$$Δ {n}_{eff} ( N E ) = {n}_{eff , core - H O M} - {n}_{eff , NE mode} .$$

If the mode index difference Δn_{eff} is close to zero, the two modes under consideration propagate substantially at the same phase propagation velocity and can therefore couple coherently (phase-locked), resulting in effective energy coupling. In this case, the energy of the higher-order core mode couples into highly lossy ARE or NE modes. Thus, energy from the higher-order core modes migrates into the modes of the anti-resonant elements, which leads to an improvement in the fundamental mode.

In the simulations described in more detail below, the effective mode index n_{eff} was extracted from the propagation constant β of the respective mode. A mode “j” is a solution of the physical system of equations:

$${E}_{j} ( x , y , z , t ) = {amplitude}_{j} ( x , y ) * exp ( i * ( {β}_{j} * z - ω * t ) ) .$$

Here
Eⱼ (x,y,z,t) describes the electric field distribution in the three spatial dimensions x,y,z at time t, and
amplitudeⱼ (x,y) describes the transverse electric field distribution.

Consequently, the propagation constant β describes the phase properties of the wave propagation along the fiber axis z. Based on the wavelength of the light λ, the effective mode index n_{eff} for mode “j” is obtained directly from β:

$${β}_{j} = 2 * pi / λ * {n}_{eff , j}$$

The propagation constant of the j-th mode—βⱼ—is generally a complex parameter as a solution to the simulation. While the real part yields n_eff,j, the waveguide loss can be derived from the imaginary part.

As will be explained in more detail, the design of the DNE element leads to effective coupling of the higher-order modes in the core with the modes in the DNE element, so that after a short travel distance only the fundamental mode propagates in the core. Optimally, the DNE element of the described anti-resonant hollow-core fiber has an ellipsoidal cross-section. Here, a closed oval curve is referred to as an ellipse, wherein the sum of the distances of an ellipse point from two points—the focal points—is the same for all points. However, due to manufacturing tolerances, the cross section of the DNE element of the disclosed anti-resonant hollow-core fiber will never be mathematically exactly ellipsoidal. Rather, the cross section of the DNE element will optimally approximate an ellipsoidal shape. Therefore, it is provided that the DNE element has an oval cross section and in the cross section a sum of the distances of any point on a DNE element wall from two focal points is the same for all points on the DNE element wall to less than 15% of the sum of the distances. This deviation from the optimal ellipsoidal cross section is, on the one hand, realistic from a manufacturing point of view and, on the other hand, continues to lead to excellent results in waveguiding.

A further embodiment is characterized in that, in cross section, the sum of the distances of any point on the DNE element wall from two focal points on the DNE element wall is the same for all points to less than 10%, in particular less than 5% of the sum of the distances.

A further embodiment is characterized in that, in cross section, the DNE element has a longest cross-sectional axis AL and/or a shortest cross-sectional axis AK. The longest cross-sectional axis AL is the axis that passes through two points on the DNE element wall that have a maximum distance from each other. The shortest cross-sectional axis AK is the axis that passes through two points on the DNE element wall that have a minimum distance from each other. In particular, one or both cross-sectional axes are axes of symmetry of the DNE element.

A further embodiment is characterized in that the focal points are arranged on the longest cross-sectional axis AL. In this embodiment, the oval cross section of the DNE element comes closer to an ellipsoidal shape, which has a positive effect on the waveguide losses.

A further embodiment is characterized in that, for the at least one anti-resonance unit, the longest cross-sectional axis AL runs parallel to a circular tangent within an angular interval of [−10 degrees; 10 degrees], wherein the circular tangent is perpendicular to the cladding inner radius. In other words, the longest cross-sectional axis AL runs substantially parallel to the inner bore. In this embodiment, the oval cross section of the DNE element comes closer to an ellipsoidal shape, which has a positive effect on the waveguide losses.

A further embodiment is characterized in that, for the at least one anti-resonance unit, the shortest cross-sectional axis AK runs
within an angular interval of [−10 degrees; 10 degrees] parallel to the cladding inner radius, and/or
within [−2 μm; 2 μm] of the fiber longitudinal axis

In other words, the shortest cross-sectional axis AK is substantially perpendicular to the inner bore.

A further embodiment is characterized in that, for a ratio of the longest cross-sectional axis AL to the shortest cross-sectional axis AK, the following applies:

$$\frac{A L}{A K} = [ 1.1 ; 4.0 ]$$

This embodiment leads to a further optimization of the waveguide losses.

A further embodiment is characterized in that, for the ratio of the longest cross-sectional axis AL to the shortest cross-sectional axis AK, the following applies:
it is greater than or equal to 1.15, in particular greater than or equal to 1.20, in particular greater than or equal to 1.25, in particular greater than or equal to 1.50; and
it is less than or equal to 3.80, in particular less than or equal to 3.60, in particular less than or equal to 3.50.

By using a DNE element with an oval cross section that has the ratios of the cross-sectional axes described above, the waveguide losses can be further reduced.

A further embodiment is characterized in that, for a ratio of the NE interior height H_NE, multiplied by doubled NE circle radius NE_R, divided by a fiber core surface area A_Faser, the following applies:

$$\frac{H\_NE * ( 2 * NE\_R )}{A\_Faser} = [ 0.35 ; 0.7 ] .$$

This embodiment is characterized in that the mode index difference Δn_{eff} (NE) is small, which means that the fundamental mode in the fiber is reached after a short travel distance and the waveguide losses are also low.

A further embodiment is characterized in that, for the ratio of the NE interior height H_NE, multiplied by the doubled NE circle radius NE_R, divided by the fiber core surface area A_Faser, the following applies:
it is greater than or equal to 0.4, in particular greater than or equal to 0.50, in particular greater than or equal to 0.56; and
it is less than or equal to 0.65, in particular less than or equal to 0.62, in particular less than or equal to 0.6.

A design of the anti-resonant hollow-core fiber based on these parameters results in a further reduction of the mode index difference Δn_{eff} (NE). This leads to a further reduction in the travel distance required to achieve the fundamental mode.

A further embodiment is characterized in that, for a ratio of an ARE interior height H_ARE divided by a core radius R_Faser, the following applies:

$$\frac{H\_ARE}{R\_Faser} = [ 0.85 ; 1.25 ] .$$

This embodiment is characterized in that the mode index difference Δn_{eff} (ARE) is small. As a result, the fundamental mode in the fiber is achieved after a short travel distance.

A further embodiment is characterized in that, for the ratio of the ARE interior height H_ARE divided by the core radius R_Faser, the following applies:
it is greater than or equal to 0.9, in particular greater than or equal to 0.95, in particular greater than or equal to 1.0; and
it is less than or equal to 1.2, in particular less than or equal to 1.15, in particular less than or equal to 1.1.

A design of the anti-resonant hollow-core fiber based on these parameters results in a further reduction of the mode index difference Δn_{eff} (ARE). This leads to a further reduction in the travel distance required to achieve the fundamental mode.

A further embodiment is characterized in that, for a ratio of the ARE interior height H_ARE, multiplied by the doubled NE circle radius NE_R, divided by the NE internal surface area A_NE, the following applies:

$$\frac{H\_ARE * ( 2 * NE\_R )}{A\_NE} = [ 0.2 ; 1. ]$$

This design of the at least one anti-resonance unit results in an anti-resonant hollow-core fiber having a small waveguide loss.

A further embodiment is characterized in that, for the ratio of the ARE interior height H_ARE, multiplied by the doubled NE circle radius NE_R, divided by the NE internal surface area A_NE, the following applies:
it is greater than or equal to 0.25, in particular greater than or equal to 0.3; and
it is less than or equal to 0.95, in particular less than or equal to 0.8.

The parameters listed for the design of the anti-resonant hollow-core fiber lead to a further reduction in the waveguide losses.

A further embodiment is characterized in that, for the ratio of the NE interior height H_NE, multiplied by the doubled NE circle radius NE_R, divided by the fiber core surface area A_Faser, the following applies:

$$\frac{H\_NE * ( 2 * NE\_R )}{A\_Faser} = [ 0.35 ; 0.7 ]$$

and additionally, for a ratio of the ARE interior height H_ARE, multiplied by the doubled NE circle radius NE_R, divided by the NE internal surface area A_NE, the following applies:

$$\frac{H\_ARE * ( 2 * NE\_R )}{A\_NE} = [ 0.2 ; 1. ]$$

This embodiment is characterized in that
the mode index difference Δn_{eff} (NE) between the fundamental mode and the NE mode is close to zero, and
the waveguide losses of the fundamental mode are minimized.

A method for producing a preform from which an anti-resonant hollow-core fiber can be elongated may comprise the following steps:
providing a fiber cladding preform,
preparing a number of anti-resonance unit preforms,
inserting the anti-resonance unit preforms into an inner bore of the fiber cladding preform, and
processing an arrangement comprising the fiber cladding preform and the number of anti-resonance unit preforms by a hot forming process selected from at least one of elongating and collapsing.

The term “hot forming process” refers to a method step in which the temperature of an element is increased by applying heat. Known hot forming processes include flame-based hot processes, which are based on the oxidation of an exothermically reacting gas. The hot forming process creates a material bond between the anti-resonance unit preforms and the inner bore of the fiber cladding preform. In the finished anti-resonant hollow-core fiber, this is reflected in the material bond between the anti-resonance units and the inner bore of the inner side of the cladding.

A further embodiment is characterized in that the anti-resonant hollow-core fiber has three, four, five, six, seven or eight anti-resonance units, in particular in that the anti-resonant hollow-core fiber has an odd number of anti-resonance units. This embodiment enables further optimization of the attenuation of the fundamental mode.

A further embodiment is characterized in that the anti-resonance units are arranged asymmetrically on the internal surface area of the cladding. As a result, the higher-order modes in the core are attenuated and the hollow-core fiber is in fundamental mode over a shorter travel distance.

A further embodiment is characterized in that the at least one of the anti-resonance units comprises at least one of the following features:
the ARE element and/or the NE element and/or the DNE element comprises an amorphous solid, in particular a glass, in particular quartz glass,
the ARE element and/or the NE element and/or the DNE element consists of an amorphous solid, in particular a glass, in particular quartz glass,
at least two of ARE element, NE element and DNE element are of the same material, in particular comprise or consist of a glass having a refractive index of at least 1.4, in particular 1.4 to 3, in particular 1.4 to 2.8, and
an element wall of at least two of ARE element, NE element and DNE element is substantially the same.

These embodiments of the anti-resonance units are optimized for low-loss transmission of signals at a wavelength between 0.3 μm and 3.0 μm, in particular between 1.0 μm and 2.5 μm.

A further embodiment is characterized in that the anti-resonant hollow-core fiber comprises at least one of the following features:
a fundamental attenuation of less than 1.0 dB/km, in particular of less than 0.25 dB/km, in particular of less than 0.1 dB/km, for a transported wavelength between 0.3 μm and 3.0 μm, in particular between 1.0 μm and 2.5 μm, and
a fundamental attenuation of less than 1 dB/km for a transported wavelength of up to 0.8 μm.

This embodiment of the anti-resonant hollow-core fiber is particularly suitable for use in data centers due to the low attenuation of the fundamental mode.

A further embodiment is characterized in that the at least one anti-resonance units comprises at least one of the following features:
a wall thickness of an ARE element wall of the ARE element and/or an NE element wall of the NE element and/or a DNE element wall of the DNE element is between 0.1 μm and 2.5 μm, in particular between 0.15 μm and 1.5 μm, in particular between 0.25 μm and 0.75 μm, in particular between 0.35 μm and 0.65 μm, in particular 0.5 μm,
a wall thickness of an ARE element wall of the ARE element and/or an NE element wall of the NE element and/or a DNE element wall of the DNE element is, at a signal wavelength of 1550 nm in the first transmission window, between 0.35 μm and 0.65 μm, in particular between 0.4 μm and 0.6 μm, in particular 0.5 μm,
a wall thickness of an ARE element wall of the ARE element and/or an NE element wall of the NE element and/or a DNE element wall of the DNE element is, at a signal wavelength of 1550 nm in the second transmission window, between 0.75 μm and 1.25 μm, in particular between 0.9 μm and 1.1 μm, in particular 1 μm.

In the case of an anti-resonant hollow-core fiber, which in particular has a DNE element with one of the specified wall thicknesses and in particular with a transported wavelength between 0.3 μm and 3.0 μm, in particular between 1.0 μm and 2.5 μm, a broad spectral range with low waveguide losses is obtained.

A further embodiment is characterized in that the core radius R_Faser comprises at least one of the following features:
it is less than or equal to 26 μm, in particular less than or equal to 23 μm, in particular less than or equal to 20 μm; and
it is greater than or equal to 10 μm, in particular greater than or equal to 12 μm, in particular greater than or equal to 14 μm.

A further embodiment is characterized in that the ARE element comprises at least one of the following features:
the first circle radius R_ARE is less than or equal to 30 μm, in particular less than or equal to 25 μm, in particular less than or equal to 22.5 μm, in particular less than or equal to 16 μm; and
the first circle radius R_ARE is greater than or equal to 5 μm, in particular greater than or equal to 7 μm, in particular greater than or equal to 11.5 μm, in particular greater than or equal to 12.25 μm, in particular greater than or equal to 14.5 μm.

In the case of anti-resonant hollow-core fibers that have one of the first circle radii R_ARE listed above, a particularly effective interaction of the higher-order modes in the core with those in the ARE element can be observed, which results in a small difference in the effective mode index Δn_{eff} (ARE). This applies in particular if the anti-resonant hollow-core fiber has one of the core radii R_Faser listed above.

A further embodiment is characterized in that the NE element comprises at least one of the following features:
the second circle radius R_NE is less than or equal to 25 μm, in particular less than or equal to 19 μm, in particular less than or equal to 17 μm,
the second circle radius R_NE is greater than or equal to 1.5 μm, in particular greater than 2.5 μm, in particular greater than or equal to 3.5 μm,
a center point angle MW_NE is less than 340°, in particular less than 330°, in particular less than 320°; and
a center point angle MW_NE is greater than 180°, in particular greater than 200°, in particular greater than 230°.

In the case of anti-resonant hollow-core fibers that have one of the second circle radii R_ARE and/or center point angle MW_NE listed above, a particularly effective interaction of the higher-order modes in the core with those in the NE element can be observed, which results in a small difference in the effective mode index Δn_{eff} (NE). This applies in particular if the anti-resonant hollow-core fiber has one of the core radii R_Faser and/or one of the first circle radii R_ARE listed above.

A further embodiment is characterized in that the DNE element comprises at least one of the following features:
the longest cross-sectional axis AL is less than or equal to 20 μm, in particular less than or equal to 16.5 μm, in particular less than or equal to 14.6 μm;
the longest cross-sectional axis AL is greater than or equal to 4 μm, in particular greater than or equal to 6.5 μm, in particular greater than or equal to 8 μm;
the shortest cross-sectional axis AK is less than or equal to 12 μm, in particular less than or equal to 9.5 μm, in particular less than or equal to 8 μm; and
the shortest cross-sectional axis AK is greater than or equal to 1.5 μm, in particular greater than or equal to 2.5 μm, in particular greater than or equal to 4 μm.

In anti-resonant hollow-core fibers that have at least one anti-resonance unit with an ARE element that has at least one of the listed features, a particularly effective interaction of the higher-order modes in the core with those in the ARE element can be observed, which results in a small difference in the effective mode index Δn_{eff} (ARE). This applies in particular if the anti-resonant hollow-core fiber has one of the core radii R_Faser and/or one of the first circle radii R_ARE listed above.

A further embodiment is characterized in that more than 70% of the anti-resonance units, in particular all anti-resonance units, have a design according to one of the described embodiments. The anti-resonance units can all be designed uniformly or according to different embodiments. Properties and features of different embodiments can be combined both separately or in any combination.

The properties and features disclosed in the description may be essential for various embodiments of the claimed invention, both separately and in any combination with one another.

The invention is further illustrated by way of example below by means of figures. The invention is not limited to the figures.

### FIGURES

In the figures,

FIG. 1 shows a tube-like shaped ARE element,

FIG. 2 shows a circular-arc-like shaped NE element,

FIG. 3 shows an oval-shaped DNE element,

FIG. 4 shows the oval-shaped DNE element from FIG. 3,

FIG. 5a shows an anti-resonance unit comprising the ARE element from FIG. 1, the NE element from FIG. 2 and the DNE element from FIG. 3,

FIG. 5b shows an enlarged detail of the anti-resonance unit from FIG. 5a,

FIG. 5c shows a further enlarged detail of the anti-resonance unit from FIG. 5a,

FIG. 6 shows a cross section through a part of an anti-resonant hollow-core fiber with the anti-resonance unit from FIG. 5,

FIG. 7 shows a cross section through the anti-resonant hollow-core fiber with a plurality of anti-resonance units,

FIG. 8 is a diagram of a difference of an effective mode index Δn_{eff} (NE), plotted as a function of a ratio of a NE interior height H_NE, multiplied by the doubled NE circle radius NE_R, divided by a fiber core surface area A_Faser,

FIG. 9 is a diagram of a waveguide loss of a fundamental mode (FM), plotted as a function of a ratio of the NE interior height H_NE, multiplied by the doubled NE circle radius NE_R, divided by the fiber core surface area A_Faser,

FIG. 10 is a diagram of a difference of the effective mode index Δn_{eff} (ARE), plotted as a function of a ratio of an ARE interior height H_ARE, divided by a core radius R_Faser

FIG. 11 is a diagram of a waveguide loss of the fundamental mode, plotted as a function of a ratio of the ARE internal height H_ARE, multiplied by the doubled NE circle radius NE_R, divided by a NE internal surface area A_NE.

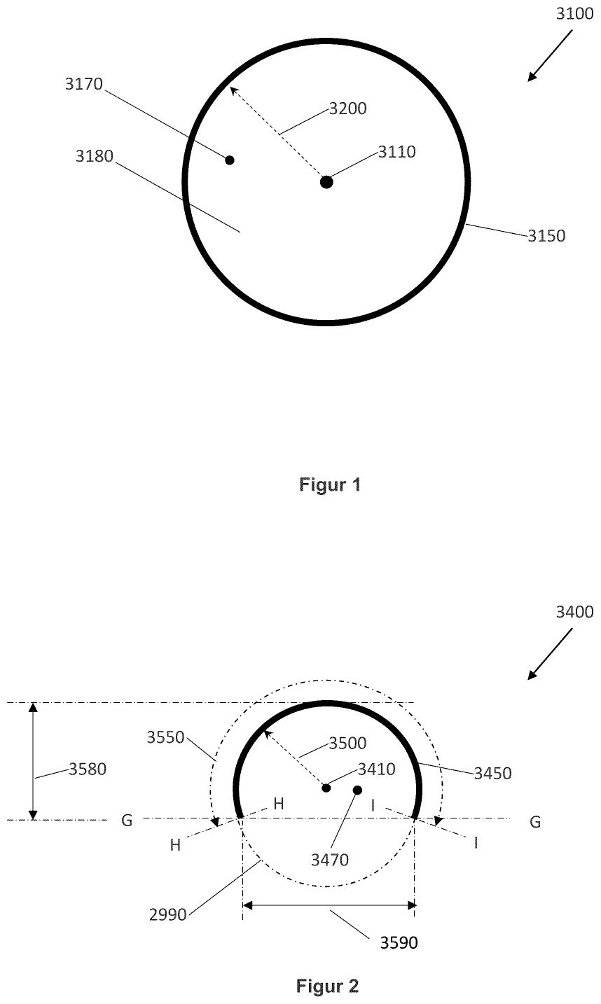

FIG. 1 shows a cross section through an ARE element 3100. The ARE element 3100 is a tube-like structure that has a circle-like or circular cross section. The ARE element 3100 extends along a first body longitudinal axis 3110. In FIG. 1, the ARE element 3100 therefore extends into the drawing plane. Due to its circle-like or circular cross section, the ARE element 3100 has a first circle radius R_ARE 3200.

The ARE element 3100 has an ARE element wall 3150. The ARE element wall 3150 encloses a first interior 3170. The first interior 3170 has an ARE internal surface area 3180. The ARE internal surface area 3180 is proportional to the square of the first circle radius R_ARE 3200.

A manufacturing-related fluctuation of the first circle radius R_ARE 3200 is in particular not more than 10%, preferably not more than 5%, more preferably not more than 3%, based on the length of the first circle radius R_ARE 3200.

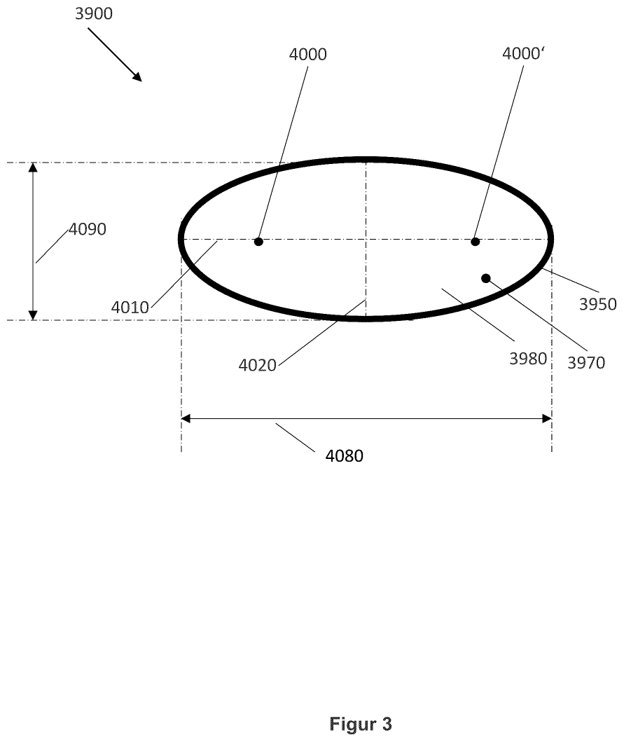

FIG. 2 shows a cross section through an NE element 3400. The NE element 3400 is a tube-like structure that has a circular-arc-like cross section. The NE element 3400 extends along a second body longitudinal axis 3410. In FIG. 2, the NE element 3400 therefore extends into the drawing plane.

As the cross section shown in FIG. 2 illustrates, the NE element 3400 has a circular-arc-like cross section. In the context of the invention, the term “circular arc” refers to a portion of a circular line. Two points on a circle divide the circle line into two circular arcs. In the context of this invention, an element is described as “circular-arc-like” if its outer shape follows the course of one of the said two circular arcs. To illustrate this, a circle 2990 is drawn in FIG. 2. This circle 2990 is divided into two circular arcs by the two intersection lines H-H and I-I. The cross section of the NE element 3400 follows one of the two circular arcs.

Furthermore, an intersection line G-G is drawn, which runs through the two intersection points of the two intersection lines H-H and I-I with the circle 2990. The chord of the NE inner unit 3400 is the distance that lies on the intersection line G-G and is delimited by the intersection lines H-H and I-I. The chord length 3590 is the length of the chord.

The NE element 3400 has an NE element wall 3450. The NE element 3400 has a second circle radius R_NE 3500. This second circle radius R_NE 3500 describes the distance of the NE element wall 3450 from the second body longitudinal axis 3410.

A manufacturing-related fluctuation of the second circle radius R_NE 3500 is in particular not more than 10%, preferably not more than 5%, more preferably not more than 3%, based on the length of the second circle radius R_ARE 3500.

The NE element 3400 has a segment height SH_NE 3580. This segment height SH_NE 3580 describes the length of a straight line that is perpendicular to the chord and runs to the vertex of the NE element wall 3450.

The NE element 3400 has a center point angle MW_NE 3550. This center point angle MW_NE 3550 describes the angle whose vertex lies in the center of the circle 2990 and whose legs intersect the boundary points of the circular arc (here the intersection points of the circle 2990 with the intersection lines H-H and I-I). A full circle has a degree value of 360°. As the NE element 3400 is shaped like a circular arc, the center point angle MW_NE 3550 is less than 360°.

The NE element 3400 has a second interior 3470 delimited by the NE element wall 3450 and the chord.

One embodiment is characterized in that the NE element 3400 comprises at least one of the following features:
the second circle radius R_NE 3500 is less than or equal to 25 μm, in particular less than or equal to 19 μm, in particular less than or equal to 17 μm,
the second circle radius R_NE 3500 is greater than or equal to 1.5 μm, in particular greater than 2.5 μm, in particular greater than or equal to 3.5 μm,
the center point angle MW_NE 3550 is less than 340°, in particular less than 330°, in particular less than 320°; and
the center point angle MW_NE 3550 is greater than 180°, in particular greater than 200°, in particular greater than 230°.

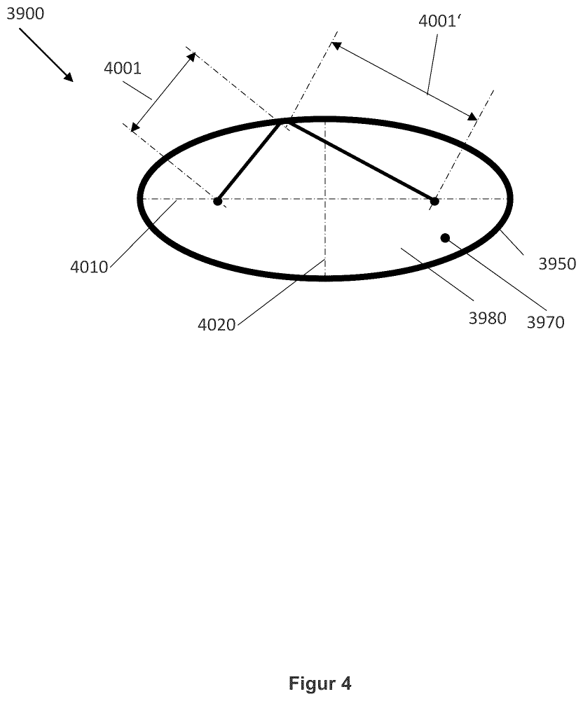

FIG. 3 shows a cross section through an DNE element 3900. The DNE element 3900 is a tube-like structure that has an oval cross section. In FIG. 2, the DNE element 3900 therefore extends into the drawing plane.

The DNE element 3900 has an DNE element wall 3950. The DNE element wall 3950 encloses a third interior 3970. The third interior 3970 has a DNE internal surface area 3980.

The DNE element 3900 is oval-shaped in cross section. In the context of the invention, the term “oval” is understood to mean a flat, rounded, convex shape, which as a special case includes ellipses, wherein any oval shape, in contrast to the ellipse, does not have to have an axis of symmetry.

The DNE element 3900 has a longest cross-sectional axis AL 4010 and a shortest cross-sectional axis AK 4020. Here,
the longest cross-sectional axis AL 4010 denotes the longest straight extension between two points on the DNE element wall 3950, and
the shortest cross-sectional axis AK 4020 denotes the shortest straight extension between two points on the DNE element wall 3950.

In a further embodiment, the longest cross-sectional axis AL 4010 and/or the shortest cross-sectional axis AK 4020 are axes of symmetry of the DNE element 3900.

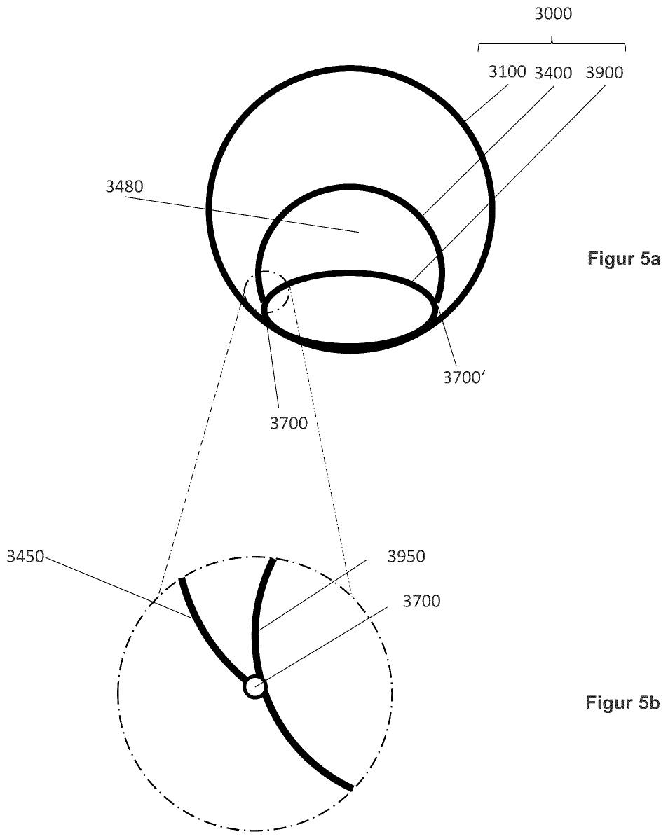

FIG. 4 serves to provide a clearer understanding of the term “oval” and shows the cross section through the DNE element 3900 shown in FIG. 3. The oval cross section of the DNE element 3900 is delimited in such a way that, in cross-section, a sum of the distances 4001, 4001′ of any point on the DNE element wall 3950 from two focal points 4000,4000′ is the same for all points to less than 15% of the sum of the distances 4001, 4001′. The focal points 4000,4000′ are disjoint and not identical. Consequently, an elliptical cross section is desired for the DNE element 3900, but for manufacturing reasons this is only achieved within the specified fluctuation. The embodiment of the DNE element 3900 shown in FIG. 4 is characterized in that the focal points 4000,4000′ lie on the longest cross-sectional axis AL 4010.

A further embodiment of the DNE element 3900 is characterized in that, in cross section, the sum of the distances 4001, 4001′ of any point on the DNE element wall 3950 from two focal points 4000,4000′, which lie in particular on the longest cross-sectional axis AL 4010, is the same for all points to less than 10%, in particular less than 5% of the sum of the distances 4001, 4001′.

Surprisingly, it has been found that a DNE element 3900 having an oval cross section positively influences the transmission properties of an anti-resonant hollow-core fiber 1000. An embodiment of the DNE element 3900 is characterized in that, for the ratio of the longest cross-sectional axis AL 4010 to the shortest cross-sectional axis AK 4020, the following applies:

$$AL / AK = [ 1.1 ; 4.0 ]$$

This embodiment leads to an optimization of the waveguide losses.

A further embodiment is characterized in that, for the ratio of the longest cross-sectional axis AL 4010 to the shortest cross-sectional axis AK 4020, the following applies:
it is greater than or equal to 1.15, in particular greater than or equal to 1.20, in particular greater than or equal to 1.25, in particular greater than or equal to 1.50; and
it is less than or equal to 3.80, in particular less than or equal to 3.60, in particular less than or equal to 3.50.

By using a DNE element 3900 which has an oval cross section that has the ratios described above, the waveguide losses can be further reduced.

A further embodiment is characterized in that the DNE element 3900 comprises at least one of the following features:
the longest cross-sectional axis AL 4010 is less than or equal to 20 μm, in particular less than or equal to 16.5 μm, in particular less than or equal to 14.6 μm;
the longest cross-sectional axis AL 4010 is greater than or equal to 4 μm, in particular greater than or equal to 6.5 μm, in particular greater than or equal to 8 μm;
the shortest cross-sectional axis AK 4020 is less than or equal to 12 μm, in particular less than or equal to 9.5 μm, in particular less than or equal to 8 μm; and
the shortest cross-sectional axis AK 4020 is greater than or equal to 1.5 μm, in particular greater than or equal to 2.5 μm, in particular greater than or equal to 4 μm.

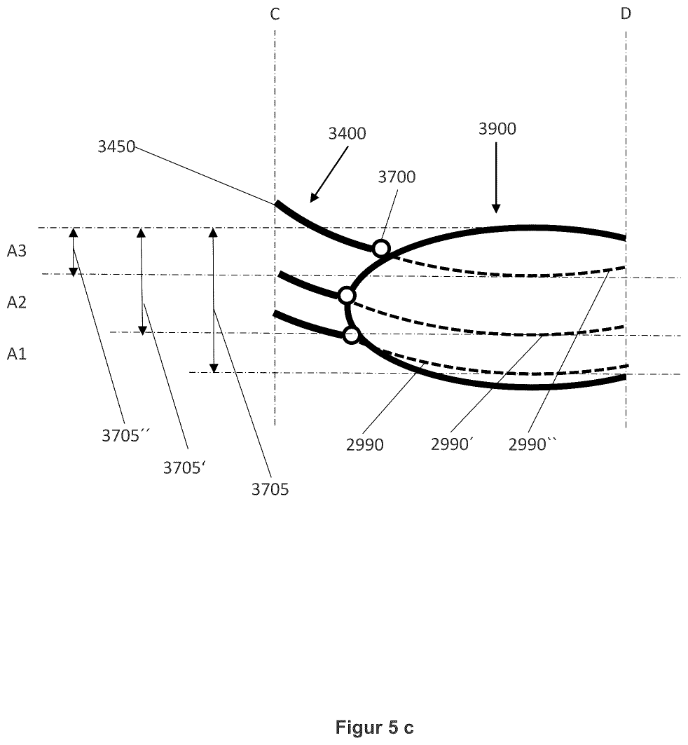

FIG. 5a shows a cross section through an anti-resonance unit 3000, which comprises the ARE element 3100, the NE element 3400, and the DNE element 3900. The NE element 3400 and the DNE element 3900 are arranged within the first interior 3170 of ARE element 3100. The oval-shaped DNE element 3900 protrudes at least partially into the second interior 3470 of the circular-arc-like NE element 3400. This means that—in cross section—the DNE element 3900 runs at least partially above the chord of the NE element 3400.

The NE element 3400 has a NE internal surface area A_NE 3480. Said NE internal surface area A_NE is delimited by the NE element wall 3450 and the DNE element wall 3950. Consequently, NE internal surface area A_NE 3480 and second interior 3470 are not exactly congruent.

The circular-arc-like shaped NE element 3400 and the oval-shaped DNE element 3900 are connected to one another along two connection seams 3700, 3700′ arranged substantially parallel to the first body longitudinal body axis 3110. In particular, this bond may have been achieved by a hot process.

To illustrate this, a region around the connection seam 3700 is shown enlarged in FIG. 5b. As a result,
the connection seams 3700 are formed as a bond between a first end point of the NE element wall 3450 and a first point on the DNE element wall 3950, and
the connection seams 3700′ are formed as a bond between a second end point of the NE element wall 3450 and a second point on the DNE element wall 3950.

Analogous to FIG. 5b, FIG. 5c shows a part of the circular-arc-like shaped NE element 3400 and the oval-shaped DNE element 3900, delimited by the intersection lines C and D.

Shown are three exemplary positions A1, A2, A3 of the respective first end point of the NE element wall 3450 on the DNE element wall 3950.

Each of the three positions A1, A2, A3 has a connection height 3705, 3705′, 3705″. The connection height 3705, 3705′, 3705″ results from a distance from an upper edge of the DNE element 3900 to the respective circle 2990, 2990′, 2990″.

For clarification, the connection height 3705″ is described in more detail for position A3. The connection height 3705″ results from the distance between the following two elements:
The upper edge of the DNE element 3900: The upper edge can be the intersection of the shortest cross-sectional axis AK 4020 with the DNE element wall 3950 (see also FIG. 3).
The circle 2990″ of the respective NE element 3400: A circle 2990 is drawn in FIG. 2 to illustrate the circular-arc-like cross section of the NE element 3400. This circle 2990 is divided into two circular arcs by the two intersection lines H-H and I-I. The cross section of the NE element 3400 follows one of the two circular arcs.

The connection height 3705″ for position A3 therefore does not correspond to the distance between a plane spanned by the connection seams 3700,3700′ and the upper edge of the DNE element 3900. Rather, the connection height 3705″ is greater than said distance to the plane spanned by the connection seams 3700,3700′.

With a connection height 3705, 3705′, 3705″ of zero, the NE element 3400 and the DNE element 3900 would touch at only one point and the NE element would virtually form a circle. In order to ensure the circular arc-like cross section of the NE element 3400, the connection height 3705, 3705′, 3705″ for the hollow-core fiber 1000 is therefore greater than zero. The connection height 3705, 3705′, 3705″ can be between 1.25 μm and 5.75 μm in one embodiment.

Since FIG. 5a,b,c each show a cross section of the anti-resonance unit 3000, in a three-dimensional illustration of the hollow-core fiber 1000, the two connection seams 3700, 3700′ run into the drawing plane.

FIGS. 1 to 5a,b,c show the anti-resonance unit 3000, the ARE element 3100, the NE element 3400, and the DNE element 3900, each in a cross section, i.e. an axial view. In a three-dimensional view, the anti-resonance unit 3000, the ARE element 3100, the NE element 3400, and the DNE element 3900 are therefore each present as an elongated and/or tube-like structure.

The ARE element 3100 and/or the NE element 3400 and/or the DNE element 3900 may comprise and/or consist of an amorphous solid, in particular a glass, in particular quartz glass. The anti-resonance unit 3000 shown in FIG. 5 may comprise at least one of the following features:
a wall thickness of the ARE element wall 3150 of the ARE element 3100 and/or the NE element wall 3450 of the NE element 3400 and/or the DNE element wall 3950 of the DNE element 3900 is between 0.1 μm and 2.5 μm, in particular between 0.15 μm and 1.5 μm, in particular between 0.25 μm and 0.75 μm, in particular between 0.35 μm and 0.65 μm, in particular 0.5 μm,
a wall thickness of the ARE element wall 3150 of the ARE element 3100 and/or the NE element wall 3450 of the NE element 3400 and/or the DNE element wall 3950 of the DNE element 3900 is, at a signal wavelength of 1550 nm in the first transmission window, between 0.35 μm and 0.65 μm, in particular between 0.4 μm and 0.6 μm, in particular 0.5 μm,
a wall thickness of the ARE element wall 3150 of the ARE element 3100 and/or the NE element wall 3450 of the NE element 3400 and/or the DNE element wall 3950 of the DNE element 3900 is, at a signal wavelength of 1550 nm in the second transmission window, between 0.75 μm and 1.25 μm, in particular between 0.9 μm and 1.1 μm, in particular 1 μm.

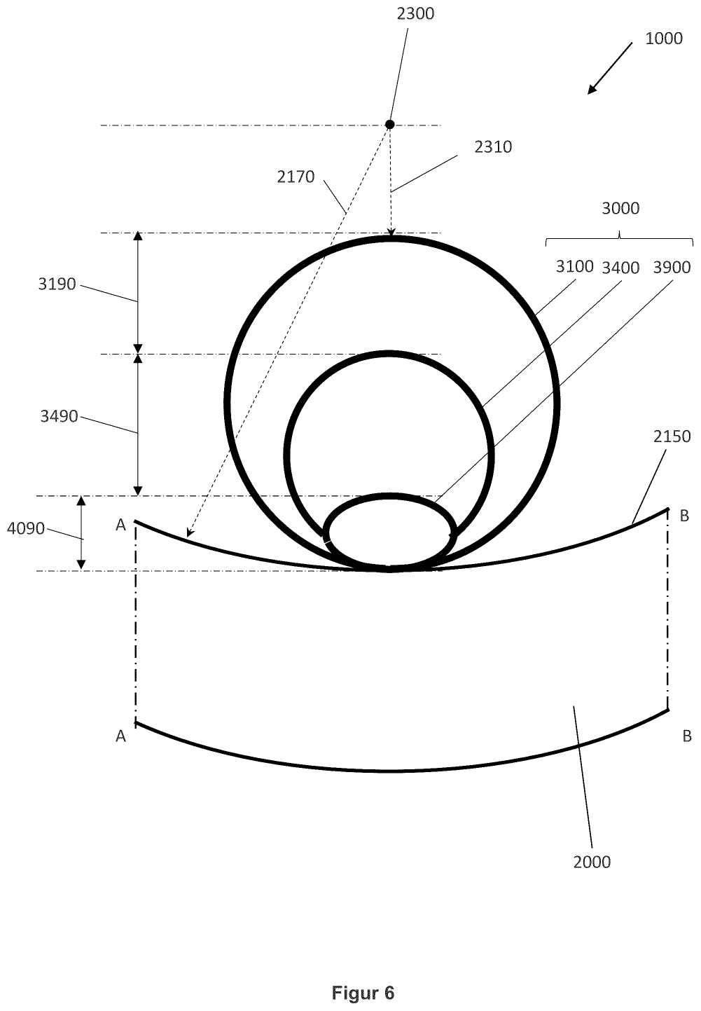

FIG. 6 shows a cross section through a part of an anti-resonant hollow-core fiber 1000. Shown is a section of the anti-resonant hollow-core fiber 1000 between two intersection lines A-A and B-B. The anti-resonant hollow-core fiber 1000 has a fiber cladding 2000 (also referred to as cladding). The fiber cladding 2000 can be constructed in one piece from an elongated cladding material or from an elongated jacket tube in combination with an elongated cladding material. The fiber cladding 2000 has a cladding inner radius 2170, which results from the distance of a fiber longitudinal axis 2300 of the anti-resonant hollow-core fiber 1000 to an inner side 2150 of the cladding 2000. An anti-resonance unit 3000 is arranged on the inner side 2150. The anti-resonance unit 3000 is materially connected to the fiber cladding 2000. The anti-resonance unit 3000 corresponds in particular to that shown in FIG. 5a.

The ARE element 3100 is circular in shape. Deviations of the ARE element wall 3150 and/or the first circle radius R_ARE 3200 from the ideal circular shape are based in particular on manufacturing-related fluctuations. In particular, the first circular radius R_ARE 3200 may not deviate by more than 15%, in particular not more than 10%, in particular not more than 3% from a mean first circle radius R_ARE 3200 of the ARE element 3100, in particular both azimuthally over a circle—so that an oval course is created—and at axially different locations of the anti-resonant hollow-core fiber 1000.

The NE element 3400 is circular-arc-like in shape. Deviations of the NE element wall 3450 and/or the second circle radius R_ARE 3500 from the ideal circular arc shape are based in particular on manufacturing-related fluctuations. In particular, the second circular radius R_ARE 3500 may not deviate by more than 15%, in particular not more than 10%, in particular not more than 3% from a mean second circle radius R_ARE 3500, in particular both azimuthally over a circular arc—so that an oval course is created—and at axially different locations of the anti-resonant hollow-core fiber 1000.

The anti-resonance unit 3000 comprises the ARE element 3100, the NE element 3400 and the DNE element 3900. An amount of the cladding inner radius 2170 corresponds to the sum of:
a core radius R_Faser 2310, which results from the shortest distance between the fiber longitudinal axis 2300 and the anti-resonance unit 3000,
an ARE interior height H_ARE 3190, which results from the distance between the ARE element wall 3150 and the NE element wall 3450 in the line to the fiber longitudinal axis 2300,
an NE interior height H_NE 3490, which results from the distance between the NE element wall 3450 and the DNE element wall 3950 in the line to the fiber longitudinal axis 2300, and
the length of the shortest cross-sectional axis AK 4090, and
the sum of the wall thicknesses of the ARE element wall 3150, the NE element wall 3450 and the DNE element wall 3950.

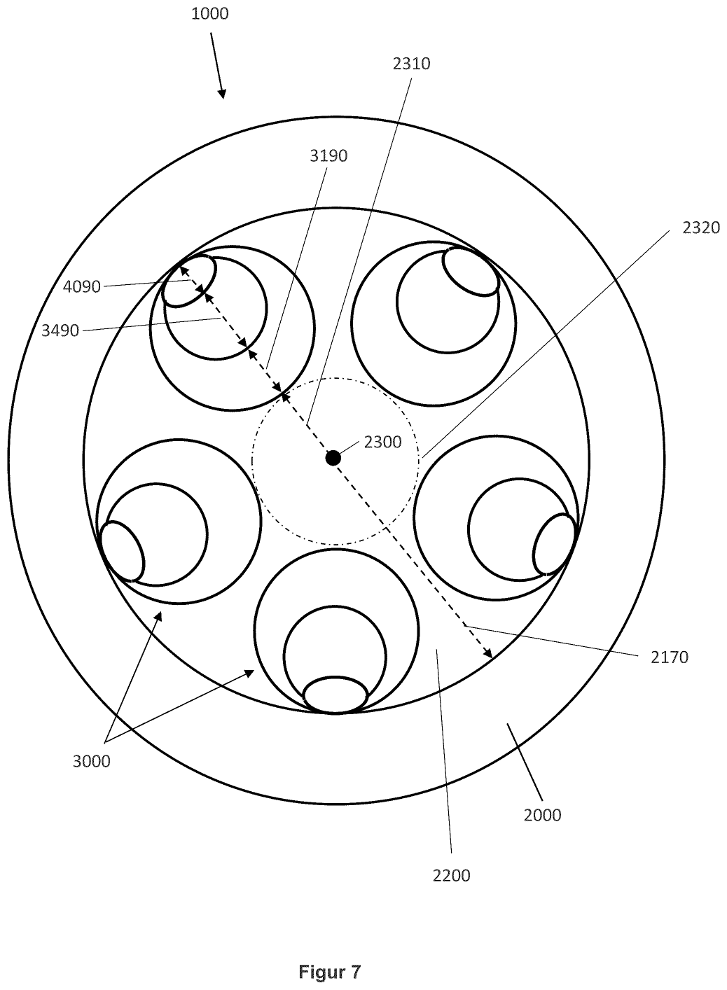

FIG. 7 shows a cross section through the anti-resonant hollow-core fiber 1000. The anti-resonant hollow-core fiber 1000 has a hollow core through which an electromagnetic wave can propagate. The hollow core has the core radius 2310 and a fiber core surface area A_Faser 2320. The fiber cladding 2000 has a circular-arc-like cross section and is tube-like in shape. In this respect, the fiber cladding 2000 encloses an inner bore 2200 in which the anti-resonance units 3000 are arranged.

One embodiment is characterized in that the core radius R_Faser 2310 comprises at least one of the following features:
it is less than or equal to 26 μm, in particular less than or equal to 23 μm, in particular less than or equal to 20 μm; and
it is greater than or equal to 10 μm, in particular greater than or equal to 12 μm, in particular greater than or equal to 14 μm.

FIG. 7 illustrates the arrangement of the plurality of anti-resonance units 3000 on the inner side 2150. In one embodiment, the anti-resonant hollow-core fiber 1000 can have three, four, five, six, seven or eight anti-resonance units 3000. In FIG. 7, the anti-resonant hollow-core fiber 1000 has five anti-resonance units 3000. In this embodiment, the anti-resonance units 3000 are arranged asymmetrically on the inner side 2150 of cladding 2000.

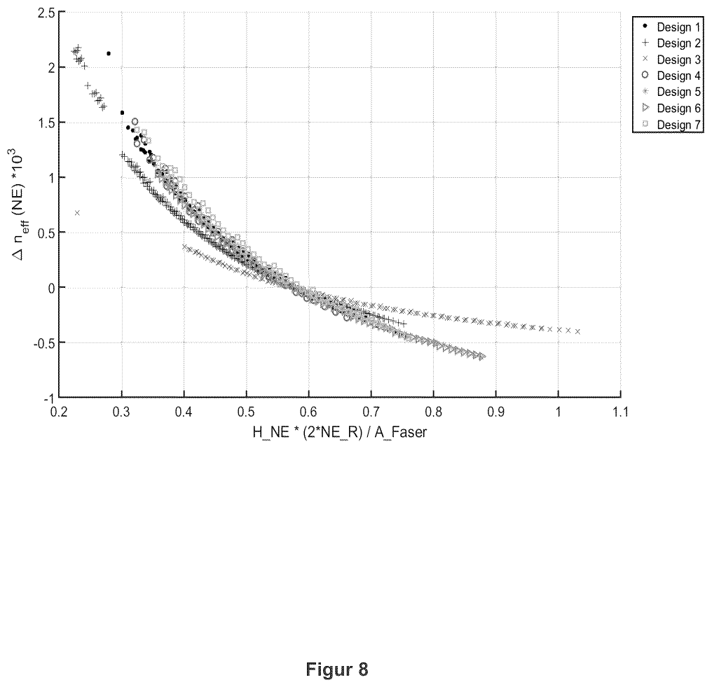

FIGS. 8 to 11 show the results of simulations of the anti-resonant hollow-core fiber 1000. A mode solver of the finite element method in the COMSOL Multiphysics program was used for the numerical calculations. A perfectly matched layer (PML) with a thickness of 10 μm was implemented at the outer interface of the optical fiber in order to investigate the radiation properties of the waveguide structure by absorbing the radially emitted light energy.

The starting point for the simulations was an anti-resonant hollow-core fiber 1000. This anti-resonant hollow-core fiber 1000 comprises the fiber longitudinal axis 2300, the fiber core radius R_Faser 2310, the fiber cladding 2000, which has the inner bore 2200. Furthermore, the anti-resonant hollow-core fiber 1000 comprises five anti-resonance units 3000, each comprising
an ARE element 3100,
an NE element 3400,
a DNE element 3900,
   in this case, the anti-resonance units 3000 are mutually spaced and are arranged so as to have no contact with one another at desired positions on an inner side 2150 of the inner bore 2200. Wherein in each anti-resonance unit 3000,
the ARE element 3100 has a circular cross section,
the NE element 3400 is arranged in a first interior 3170 of the ARE element 3100, and
the DNE element 3900 is arranged at least partially into a second interior 3470 of the NE element 3400.

The anti-resonance units 3000 in the anti-resonant hollow-core fiber 1000 are characterized in that
the DNE element 3900 has an oval cross section,
the NE element 3400 has a circular-arc-like cross section and is connected to the DNE element 3400 along two connection seams 3700, 3700′, and
in cross section, a sum of the distances of any point on a DNE element wall 3950 from two focal points 4000,4000′ is the same for all points to less than 15% of the sum of the distances.

The simulated anti-resonant hollow-core fibers 1000 comprised the following properties:
a wall thickness of 500 nm, which in particular corresponds to a wide transmission range (1st transmission band) around the signal wavelength of 1550 nm,
five anti-resonance units 3000 in each case, and
the DNE elements had the contour of an ideal ellipse.

Table 1 shows further parameters of the seven different designs of the simulated anti-resonant hollow-core fiber 1000.

| | Design | Design | Design | Design | Design | Design | Design |
|---|---|---|---|---|---|---|---|
| | 1 | 2 | 3 | 4 | 5 | 6 | 7 |
| Core radius R_Faser | 14 | 16 | 20 | 14 | 14 | 14 | 14 |
| 2310 [μm] | | | | | | | |
| First circle radius | 14.5 | 16 | 22.5 | 14.5 | 14.5 | 14.5 | 14.5 |
| R_ARE 3200 [μm] | | | | | | | |
| Second circle radius | [6.0; | [6.0; | [9.5; | [5.5; | [5.0; | [5.5; | [5.5; |
| R_NE 3500 [μm], in | 12.0] | 13.5] | 19.0] | 11.5] | 12.75] | 12.5] | 12.5] |
| 0.5 μm steps | | | | | (in | | |
| | | | | | 0.25 μm | | |
| | | | | | steps) | | |
| Diameter of oval (AL | 9 (AL: | 9 (AL: | 11 | 9 (AL: | 9 (AL: | 6 (AL: | 11 |
| 4010 + AK 4020)/2 | 6.0; | 6.0; | (AL: | 5.0; | 6.75 | 4.0; | (AL: |
| [μm] | AK: | AK: | 7.33; | AK: | AK: | AK: | 7.33; |
| | 3.0) | 3.0) | AK: | 4.0) | 2.25) | 2.0) | AK: |
| | | | 3.67) | | | | 3.67) |
| Ovality (AL 4010/ | 2 | 2 | 2.00 | 1.25 | 3.5 | 2 | 2.00 |
| AK 4020) | | | | | | | |
| Penetration depth of | 1 | 1 | 1 | 1 | 1 | 1 | 1 |
| ARE element into the | | | | | | | |
| cladding [μm] | | | | | | | |
| Connection height | [3.25; | [3.25; | [2.5; | [4.0; | [3.0; | [2.0; | [5.0; |
| 3705, 3705′, 3705″ | 5.75] | 5.75] | 6.0] | 7.5] | 4.75] | 3.75] | 7.25] |
| [μm] | Step 0.25 | Step 0.25 | Step 0.50 | Step 0.50 | Step 0.25 | Step 0.25 | Step 0.25 |
| Penetration depth of | 0.25 | 0.25 | 0.25 | 0.25 | 0.1 | 0.25 | 0.25 |
| DNE element into the | | | | | | | |
| cladding [μm] | | | | | | | |
| Cladding inner radius | 42 | 47 | 64 | 42 | 42 | 42 | 42 |
| 2170 [μm] | | | | | | | |
| Distance of anti- | 4.5 | 5.6 | 4.96 | 4.5 | 4.5 | 4.5 | 4.5 |
| resonance units 3000 | | | | | | | |
| [μm] | | | | | | | |

A plurality of calculations were performed for each of the total of seven designs. The following parameters were varied:
1. second circle radius R_NE 3500, and
2. the connection height 3705, 3705′, 3705″, i.e. the position of the NE element on the DNE element.

### Regarding 1.:

For the otherwise fixed design, the second circle radius R_NE 3500 was varied in 500 nm steps (except for Design 5). For example, the interval listed for Design 1
[3.5; 11.0]
   indicates that during the simulation, the second circle radius R_NE 3500 was varied in 0.5 μm steps in the interval [3.5 μm; 11.0 μm].

### Regarding 2.:

For the otherwise fixed design, the position of the NE element on the DNE element was varied (cf. FIG. 5c). For example, the interval listed for Design 1
[1.25; 5.75] Step 0.50
   indicates that the connection height 3705, 3705′, 3705″ was varied during the simulation in 0.5 μm steps from 1.25 μm to 5.75 μm.

Further parameters are defined as follows:
The value “diameter of oval”, calculated from the arithmetic mean of the longest cross-sectional axis AL and the shortest cross-sectional axis AK:
   ((AL 4010+AK 4020)/2).
The value “ovality” is calculated from the ratio of the longest cross-sectional axis AL to the shortest cross-sectional axis AK (AL 4010/AK 4020).
The penetration depth of ARE element into the cladding indicates that the ARE element penetrates 1 μm into the cladding during the hot process.
The penetration depth of DNE element into the cladding indicates that the DNE element penetrates 0.25 μm into the cladding during the hot process.

In FIGS. 8 to 11, the results of simulations are plotted as follows:
results based on Design 1 are marked as dots,
results based on Design 2 are marked as crosses,
results based on Design 3 are marked with an x,
results based on Design 4 are marked as circles,
results based on Design 5 are marked with a star,
results based on Design 6 are marked with a triangle, and
results based on Design 7 are marked as rectangles.

In addition to the definitions given above, the following modes were considered in the simulation:
higher-order modes in the core
   in the simulations, only the second-order modes (i.e. the first-order modes above the fundamental mode) were considered, as modes of the third and higher order typically have even higher waveguide losses and are therefore less relevant for the consideration of the fundamental mode, which is predominantly determined by the power and the waveguide losses in the second-order modes;
modes in the ARE element
   only the fundamental mode in the ARE element was considered in the simulations;
modes in the NE element
   only the fundamental mode in the NE element was considered in the simulations.

In the simulation, the effective mode index n_{eff} was extracted from the propagation constant β of the respective mode. A mode “j” is a solution of the physical system of equations:

$${E}_{j} ( x , y , z , t ) = {amplitude}_{j} ( x , y ) * exp ( i * ( {β}_{j} * z - ω * t ) ) .$$

### Here

Eⱼ (x,y,z,t) describes the electric field distribution in the three spatial dimensions x,y,z at time t,
amplitudeⱼ (x,y) describes the transverse electric field distribution.

Consequently, the propagation constant β describes the phase properties of the wave propagation along the fiber axis z. Based on the wavelength of light λ, n_{eff} for mode “j” is obtained directly from β:

$${β}_{j} = 2 * pi / λ * {n}_{eff , j}$$

The propagation constant of the j-th mode—βⱼ—is generally a complex parameter as a solution to the simulation. While the real part yields n_eff,j, the waveguide losses, which were determined for the core modes, can be derived from the imaginary part. The parameter βⱼ therefore contains all the properties that are essential here.

The above-mentioned disadvantages of known anti-resonant hollow-core fibers are also overcome, in particular, when a fast fundamental mode is achieved. This means that the higher-order modes are attenuated in the core and the anti-resonant hollow-core fiber effectively behaves as in fundamental mode after a shorter travel distance. The shorter this travel distance, the higher the fundamental mode. The physical background is that the energy of the higher-order modes in the core couples into the ARE modes and/or DNE modes, which are more lossy. This means that the higher-order modes no longer make a disruptive contribution to the light signal transmission in the core. The simulation of the anti-resonant hollow-core fiber 1000 surprisingly showed that the oval geometry of the DNE element 3900 influences the fundamental mode.

In FIG. 8, the difference of the effective mode index Δn_{eff} (NE) for the simulated designs is plotted against the ratio of the NE interior height H_NE 3490, multiplied by the doubled NE circle radius NE_R 3500, divided by the fiber core surface area A_Faser 2320.

The desired coupling between the fundamental mode and the NE modes—and thus the good fundamental mode—is achieved when the magnitude of the mode index Δn_{eff} (NE) is small, in particular zero. It has proven to be advantageous if, for the ratio of the NE interior height H_NE 3490, multiplied by the doubled NE circle radius NE_R 3500, divided by the fiber core surface area A_Faser 2320, the following applies:

$$\frac{H\_NE * ( 2 * NE\_R )}{A\_Faser} = [ 0.35 ; 0.7 ]$$

A further positive influence on the fundamental mode can be achieved if, for the ratio of the NE interior height H_NE 3490, multiplied by the doubled NE circle radius NE_R 3500, divided by the fiber core surface area A_Faser 2320, the following applies:
it is greater than or equal to 0.4, in particular greater than or equal to 0.50, in particular greater than or equal to 0.56; and
it is less than or equal to 0.65, in particular less than or equal to 0.62, in particular less than or equal to 0.6.

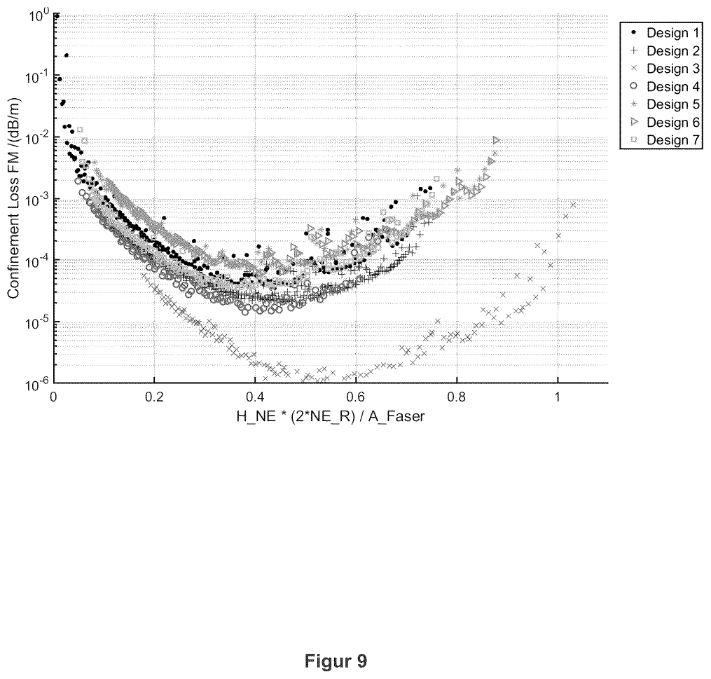

In FIG. 9, the waveguide losses for the simulated designs of the anti-resonant hollow-core fiber 1000 are plotted against the—also plotted in FIG. 8—ratio of the NE interior height H_NE 3490, multiplied by the doubled NE circle radius NE_R 3500, divided by the fiber core surface area A_Faser 2320. The aim is to achieve the lowest possible waveguide loss. This is achieved for the simulated designs if the following applies:

$$\frac{H\_NE * ( 2 * NE\_R )}{A\_Faser} = [ 0.35 ; 0.7 ]$$

This interval corresponds to the optimal interval for the fundamental mode.

FIGS. 8 and 9 illustrate the special features of the described anti-resonant hollow-core fiber 1000. A geometric design of the anti-resonant hollow-core fiber 1000 according to

$$\frac{H\_NE * ( 2 * NE\_R )}{A\_Faser} = [ 0.35 ; 0.7 ]$$

results in the following advantages:
This geometric design of the anti-resonant hollow-core fiber 1000 results in the difference of the effective mode index Δn_{eff} (NE) being close to or equal to zero. Consequently, higher-order modes in the core and the modes in the NE element propagate at approximately the same phase propagation velocity and can therefore couple coherently (in phase-locked), resulting in effective energy coupling. Thus, energy migrates from the higher-order core modes into the ARE modes and/or DNE modes, which leads to an improvement of the fundamental mode.
Furthermore, this geometric design of the anti-resonant hollow-core fiber 1000 enables a low waveguide loss. The fundamental mode of the anti-resonant hollow-core fiber 1000 is subject to low attenuation. For commercial use of the anti-resonant hollow-core fiber 1000, only a small number of amplifiers are required to bridge a large distance.

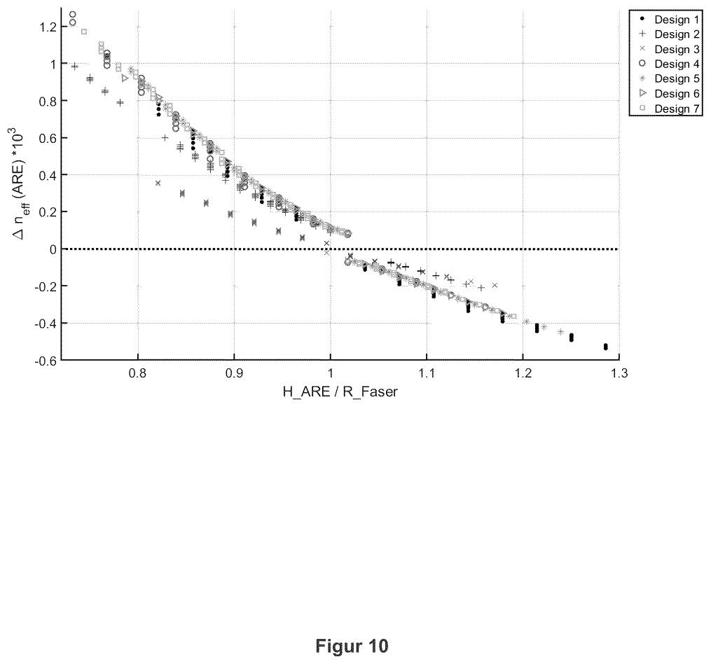

In FIG. 10 the difference of the effective mode index Δn_{eff} (ARE) plotted against the ratio of the ARE interior height H_ARE 3190 divided by the core radius R_Faser 2310. It has been found to be advantageous if, for the ratio of the ARE interior height H_ARE 3190 divided by the core radius R_Faser 2310, the following applies:

$$\frac{H\_ARE}{R\_Faser} = [ 0.85 ; 1.25 ]$$

This geometric design of the anti-resonant hollow-core fiber 1000 results in the difference of the effective mode index Δn_{eff} (ARE) being close to or equal to zero.

A further positive influence on the fundamental mode can be achieved if, for the ratio of the ARE interior height H_ARE 3190 divided by the core radius R_Faser 2310, the following applies:
it is greater than or equal to 0.9, in particular greater than or equal to 0.95, in particular greater than or equal to 1.0; and
it is less than or equal to 1.2, in particular less than or equal to 1.15, in particular less than or equal to 1.1.

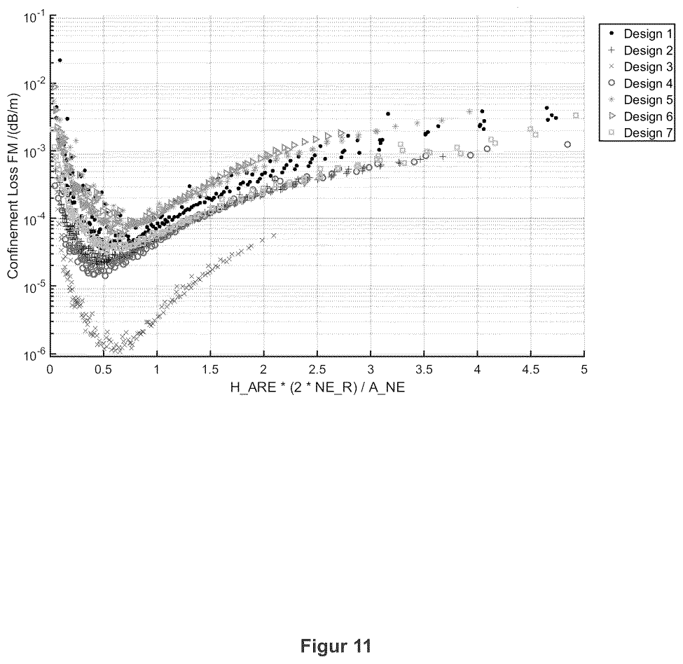

In FIG. 11, the waveguide losses for the designs of the anti-resonant hollow-core fiber 1000 are plotted against the ratio of the ARE interior height H_ARE 3190, multiplied by the doubled NE circle radius NE_R 3500, divided by the NE internal area A_NE 3480. It has proven to be advantageous if, for the ratio of the ARE interior height H_ARE 3190, multiplied by the doubled NE circle radius NE_R 3500, divided by the NE internal surface area A_NE 3480, the following applies:

$$\frac{H\_ARE * ( 2 * NE\_R )}{A\_NE} = [ 0.2 ; 1. ]$$

A further positive influence on the waveguide losses can be achieved if, for the ratio of the ARE interior height H_ARE 3190, multiplied by the doubled NE circle radius NE_R 3500, divided by the NE internal surface area A_NE 3480, the following applies:
it is greater than or equal to 0.25, in particular greater than or equal to 0.3; and
it is less than or equal to 0.95, in particular less than or equal to 0.8.

A further positive influence
1. on the coupling of the higher-order modes in the core with the modes in the anti-resonance units 3000, and
2. on the waveguide losses of the fundamental mode can be achieved if at least two of the following apply to the anti-resonant hollow-core fiber 1000:
   the ratio of the longest cross-sectional axis AL 4010 to the shortest cross-sectional axis AK 4020 is

$$\frac{AL}{AK} = [ 1.1 ; 4. ]$$

the ratio of the NE interior height H_NE 3490, multiplied by the doubled NE circle radius NE_R 3500, divided by the fiber core surface area A_Faser 2320, is

$$\frac{H\_NE * ( 2 * NE\_R )}{A\_Faser} = [ 0.35 ; 0.7 ]$$

the ratio of the ARE interior height H_ARE 3190 divided by the core radius R_Faser 2310 is

$$\frac{H\_ARE}{R\_Faser} = [ 0.85 ; 1.25 ]$$

the ratio of the ARE interior height H_ARE 3190, multiplied by the doubled NE circle radius NE_R 3500, divided by the NE internal surface area A_NE 3480, is

$$\frac{H\_ARE * ( 2 * NE\_R )}{A\_NE} = [ 0.2 ; 1. ]$$

### REFERENCE SIGNS

100 anti-resonant hollow-core fiber
2000 cladding or fiber cladding
2150 inner side of the cladding
2170 cladding inner radius
2300 fiber longitudinal axis
2310 core radius R_Faser
2320 fiber core surface area A_Faser
2990 circle
3000 anti-resonance unit, or ARE unit
3100 ARE element
3110 first body longitudinal axis
3150 ARE element wall
3170 first interior of the ARE element
3180 ARE internal surface area
3190 ARE interior height H_ARE
3200 first circle radius R_ARE
3400 NE element
3410 second body longitudinal axis
3450 NE element wall
3470 second interior of the NE element
3480 NE internal surface area A_NE
3490 NE interior height H_NE
3500 second circle radius R_NE
3550 center point angle MW_NE
3580 segment height SH_NE
3590 chord length
3700,3700′ connection seam
3705, 3705′, 3705″ connection height
3900 DNE element of the anti-resonant hollow-core fiber
3950 DNE element wall
3970 third interior of the DNE element
3980 DNE internal surface area A_DNE
4000, 4000′ two focal points
4010 longest cross-sectional axis AL
4020 shortest cross-sectional axis AK
4080 length of the longest cross-sectional axis AL
4090 length of the shortest cross-sectional axis AK

1. An anti-resonant hollow-core fiber, comprising
a fiber cladding which comprises an inner bore,
a fiber longitudinal axis and a fiber core radius R_Faser,
a number of anti-resonance units, each comprising
an ARE element,
an NE element,
a DNE element,
wherein the anti-resonance units are mutually spaced and are arranged so as to have no contact with one another at desired positions on an inner side of the inner bore,
wherein in the anti-resonance units
the ARE element has a circular cross section,
the NE element is arranged in a first interior of the ARE element, and
the DNE element is arranged at least partially into a second interior of the NE element,
wherein in at least one anti-resonance unit
the NE element has a circular-arc-like cross section and is connected to the DNE element along two connection seams,
the DNE element has an oval cross section, and
in cross section, a sum of the distances of any point on a DNE element wall from two focal points is the same for all points to less than 15% of the sum of the distances.

2. The anti-resonant hollow-core fiber according to claim 1, wherein in cross section, the sum of the distances of any point on the DNE element wall from two focal points is the same for all points to less than 10%, in particular less than 5% of the sum of the distances.

3. The anti-resonant hollow-core fiber according to claim 1, wherein the DNE element has a longest cross-sectional axis AL and a shortest cross-sectional axis AK and, for a ratio of the longest cross-sectional axis AL to the shortest cross-sectional axis AK, the following applies:
$$\frac{AL}{AK} = [ 1.1 ; 4. ]$$

4. The anti-resonant hollow-core fiber according to claim 3, wherein for the ratio of the longest cross-sectional axis AL to the shortest cross-sectional axis AK, the following applies:
it is greater than or equal to 1.15, in particular greater than or equal to 1.20, in particular greater than or equal to 1.25, in particular greater than or equal to 1.50; and
it is less than or equal to 3.80, in particular less than or equal to 3.60, in particular less than or equal to 3.50.

5. The anti-resonant hollow-core fiber according to claim 1, wherein for a ratio of an NE interior height H_NE, multiplied by a doubled NE circle radius NE_R, divided by a fiber core surface area A_Faser, the following applies:
$$\frac{H\_NE * ( 2 * NE\_R )}{A\_Faser} = [ 0.35 ; 0.7 ]$$

6. The anti-resonant hollow-core fiber according to claim 5, wherein for the ratio of the NE interior height H_NE, multiplied by the doubled NE circle radius NE_R, divided by the fiber core surface area A_Faser, the following applies:
it is greater than or equal to 0.4, in particular greater than or equal to 0.50, in particular greater than or equal to 0.56; and
it is less than or equal to 0.65, in particular less than or equal to 0.62, in particular less than or equal to 0.6.

7. The anti-resonant hollow-core fiber according to claim 1, wherein for a ratio of an ARE interior height H_ARE divided by a core radius R_Faser, the following applies:
$$\frac{H\_ARE}{R\_Faser} = [ 0.85 ; 1.25 ]$$

8. The anti-resonant hollow-core fiber according to claim 7, wherein for the ratio of the ARE interior height H_ARE divided by the core radius R_Faser, the following applies:
it is greater than or equal to 0.9, in particular greater than or equal to 0.95, in particular greater than or equal to 1.0; and
it is less than or equal to 1.2, in particular less than or equal to 1.15, in particular less than or equal to 1.1.

9. The anti-resonant hollow-core fiber according to claim 1, wherein for a ratio of the ARE interior height H_ARE, multiplied by the doubled NE circle radius NE_R, divided by an NE internal surface area A_NE, the following applies:
$$\frac{H\_ARE * ( 2 * NE\_R )}{A\_NE} = [ 0.2 ; 1. ]$$

10. The anti-resonant hollow-core fiber according to claim 9, wherein for the ratio of the ARE interior height H_ARE, multiplied by the doubled NE circle radius NE_R, divided by the NE internal surface area A_NE, the following applies:
it is greater than or equal to 0.25, in particular greater than or equal to 0.3; and
it is less than or equal to 0.95, in particular less than or equal to 0.8.

11. The anti-resonant hollow-core fiber according to claim 1, wherein the at least one anti-resonance unit comprises at least one of the following features:
a wall thickness of an ARE element wall of the ARE element and/or an NE element wall of the NE element and/or a DNE element wall of the DNE element is between 0.1 μm and 2.5 μm, in particular between 0.15 μm and 1.5 μm, in particular between 0.25 μm and 0.75 μm, in particular between 0.35 μm and 0.65 μm, in particular 0.5 μm,
a wall thickness of an ARE element wall of the ARE element and/or an NE element wall of the NE element and/or a DNE element wall of the DNE element is, at a signal wavelength of 1550 nm in the first transmission window, between 0.35 μm and 0.65 μm, in particular between 0.4 μm and 0.6 μm, in particular 0.5 μm,
a wall thickness of an ARE element wall of the ARE element and/or an NE element wall of the NE element and/or a DNE element wall of the DNE element is, at a signal wavelength of 1550 nm in the second transmission window, between 0.75 μm and 1.25 μm, in particular between 0.9 μm and 1.1 μm, in particular 1 μm.

12. The anti-resonant hollow-core fiber according to claim 1, wherein the core radius R_Faser comprises at least one of the following features:
it is less than or equal to 26 μm, in particular less than or equal to 23 μm, in particular less than or equal to 20 μm; and
it is greater than or equal to 10 μm, in particular greater than or equal to 12 μm, in particular greater than or equal to 14 μm.

13. The anti-resonant hollow-core fiber according to claim 1, wherein the ARE element comprises at least one of the following features:
a first circle radius R_ARE is less than or equal to 30 μm, in particular less than or equal to 25 μm, in particular less than or equal to 22.5 μm, in particular less than or equal to 16 μm; and
the first circle radius R_ARE is greater than or equal to 5 μm, in particular greater than or equal to 7 μm, in particular greater than or equal to 11.5 μm, in particular greater than or equal to 12.25 μm, in particular greater than or equal to 14.5 μm.

14. The anti-resonant hollow-core fiber according to claim 1, wherein the NE element comprises at least one of the following features:
a second circle radius R_NE is less than or equal to 25 μm, in particular less than or equal to 19 μm, in particular less than or equal to 17 μm,
the second circle radius R_NE is greater than or equal to 1.5 μm, in particular greater than 2.5 μm, in particular greater than or equal to 3.5 μm,
a center point angle MW_NE is less than 340°, in particular less than 330°, in particular less than 320°; and
the center point angle MW_NE is greater than 180°, in particular greater than 200°, in particular greater than 220°.

15. The anti-resonant hollow-core fiber according to claim 3, wherein the DNE element comprises at least one of the following features:
the longest cross-sectional axis AL is less than or equal to 20 μm, in particular less than or equal to 16.5 μm, in particular less than or equal to 14.6 μm;
the longest cross-sectional axis AL is greater than or equal to 4 μm, in particular greater than or equal to 6.5 μm, in particular greater than or equal to 8 μm;
the shortest cross-sectional axis AK is less than or equal to 12 μm, in particular less than or equal to 9.5 μm, in particular less than or equal to 8 μm; and
the shortest cross-sectional axis AK is greater than or equal to 1.5 μm, in particular greater than or equal to 2.5 μm, in particular greater than or equal to 4 μm.
